(19) United States
(12) Patent Application Publication
(10) Pub. No.: US 2014/0375005 A1
(43) Pub. Date: Dec. 25, 2014

(54) CASTER SWITCH UNIT FOR CARRY-AND-TRANSPORT DEVICE

(71) Applicant: Sunpex Technology Co., Ltd., Chia Yicity (TW)

(72) Inventors: SAMUEL LIN, CHIA YI CITY (TW); YAN-SHENG LIN, CHIA YI CITY (TW); I-PING HUANG, CHIA-YI CITY (TW)

(21) Appl. No.: 13/926,028

(22) Filed: Jun. 25, 2013

(51) Int. Cl. B62B 3/02

(52) U.S. Cl. CPC B62B 3/02
USPC 280/86.5

(57) ABSTRACT

A carry-and-transport device includes a caster unit and a straight-wheel unit. A control unit which has a sleeve and the sleeve is located corresponding to the straight-wheel unit of the carry-and-transport device. A movable frame is connected to the sleeve and has an auxiliary caster unit connected to the lower end thereof. The auxiliary caster unit normally located above the ground and does not contact the ground. A switch unit is connected to the top of the movable frame so as to control the movable frame to move upward and downward. When the carry-and-transport device turns or makes a U-turn, the auxiliary caster unit touches the ground by operation of the control unit so as to reduce the turning radius of the carry-and-transport device.

### BACKGROUND OF THE INVENTION

1. Field of the Invention

The present invention relates to a caster switch unit for a carry-and-transport device, and more particularly, to a caster switch unit for reducing the turning radius of the carry-and-transport device.

2. Description of Related Art

The conventional carry-and-transport devices, such as stroller carts, shopping carts and transportation carts, are used for carry objects or goods from one place to another to save energy and transportation time. Besides, some of the carry-and-transport devices are used for moving patients in hospitals or between clinic rooms.

However, when using the carry-and-transport devices, the users are experienced that a larger area is required when turning these carry-and-transport devices. In other words, the turning radius for the conventional carry-and-transport devices is not satisfied by the uses so that when the carry-and-transport devices are used in a narrow space, it is difficult to turn or make a U-turn.

The present invention intends to provide a caster switch unit for a carry-and-transport device so as to reduce the turning radius and to improve the shortcomings of the conventional carry-and-transport devices.

### SUMMARY OF THE INVENTION

The present invention relates to a carry-and-transport device and comprises a caster unit and a straight-wheel unit. A control unit has a sleeve which is located corresponding to the straight-wheel unit. A movable frame is connected to the sleeve and has an auxiliary caster unit connected to the lower end thereof. The auxiliary caster unit is normally located above the ground. A switch unit is connected to the top of the movable frame which controls the movable frame to move upward and downward.

Preferably, the carry-and-transport device is a transportation cart, a manual cart or a bed.

Preferably, the switch unit of the control unit is a lever.

Preferably, the switch unit of the control unit is a hydraulic cylinder, a pneumatic cylinder or an electric cylinder.

The primary object of the present invention is to provide a carry-and-transport device which has a control unit which is located corresponding to the straight-wheel unit of the carry-and-transport device. When the carry-and-transport device turns or makes a U-turn, the auxiliary caster unit touches the ground by operation of the control unit so as to reduce the turning radius of the carry-and-transport device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the carry-and-transport device of the present invention;

FIG. 2 is a front view of the carry-and-transport device of the present invention;

FIG. 3 is a side view of the carry-and-transport device of the present invention;

FIG. 4 is an enlarged view to show a portion of the carry-and-transport device of the present invention;

FIG. 5 is a side view to show the operation of the carry-and-transport device of the present invention, and

FIG. 6 is an enlarged view to show a portion of the carry-and-transport device of the present invention when in use.

### DETAILED DESCRIPTION OF THE PREFERRED EMBODIMENT

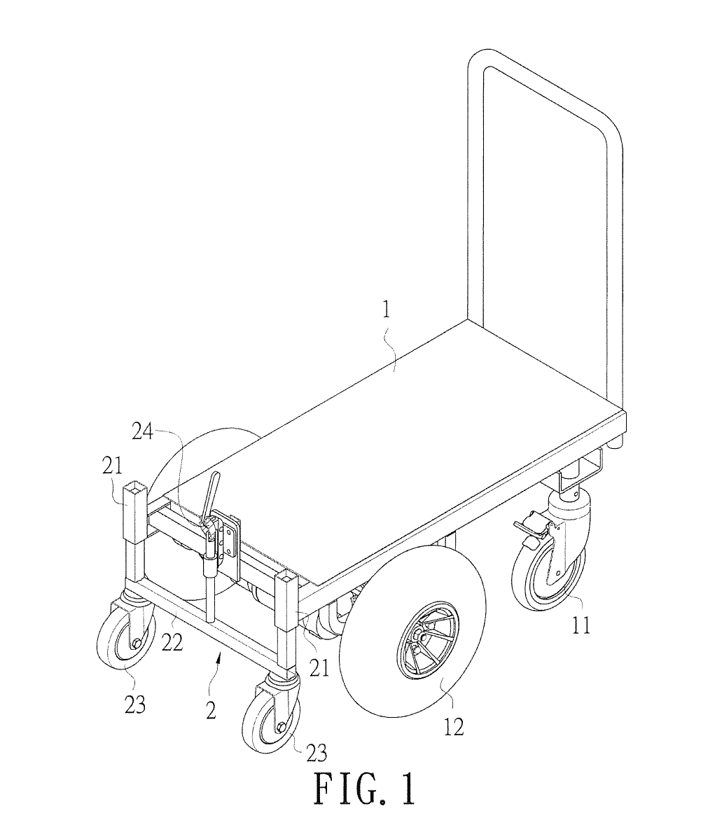

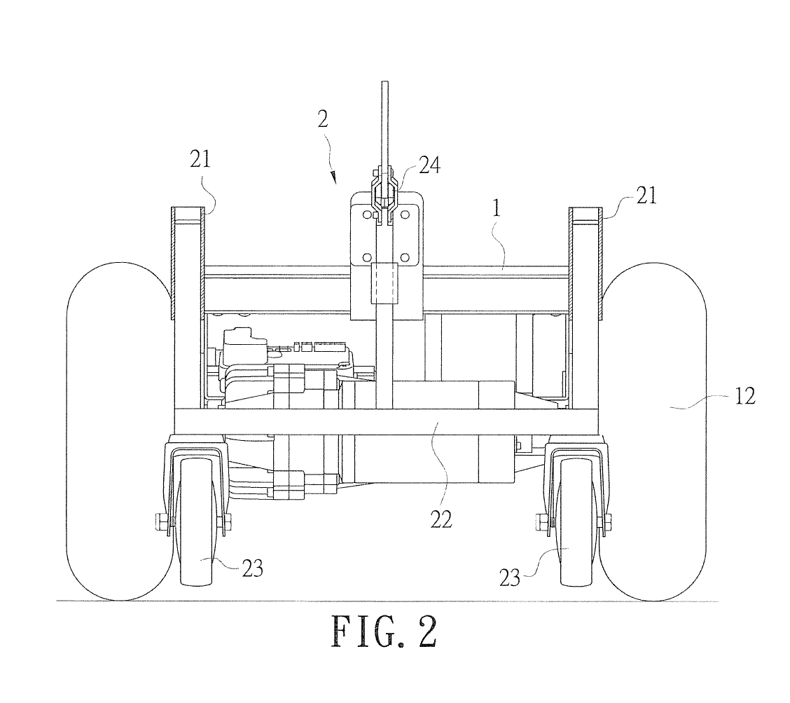

Referring to FIGS. 1 and 2, a carry-and-transport device 1 of the present invention comprises a caster unit 11 and a straight-wheel unit 12. The carry-and-transport device 1 of the present invention can be a transportation cart, a manual cart or a bed.

A control unit 2 has a sleeve 21 which is located corresponding to the straight-wheel unit 12. A movable frame 22 is connected to the sleeve 21 and has an auxiliary caster unit 23 connected to the lower end thereof.

The auxiliary caster unit 23 is normally located above the ground and does not contact the ground. A switch unit 24 is connected to the top of the movable frame 22 which controls the movable frame 22 to move upward and downward. The switch unit 24 of the control unit 2 is a lever, a hydraulic cylinder, a pneumatic cylinder or an electric cylinder.

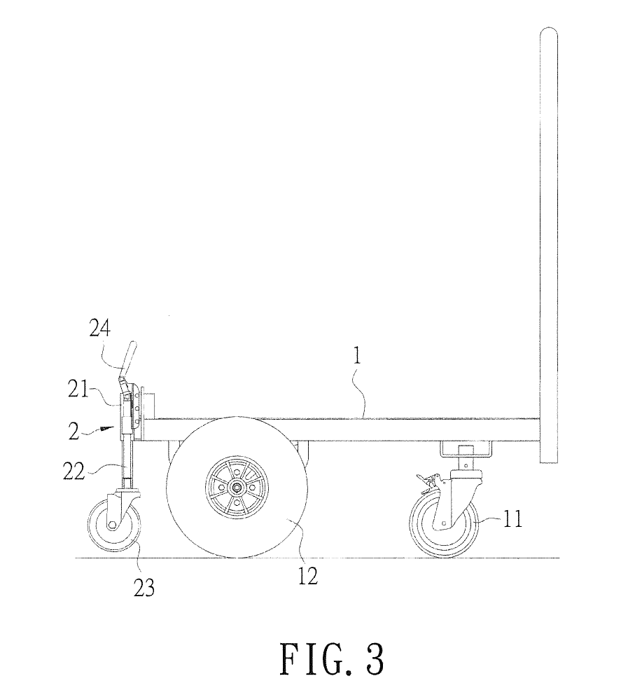

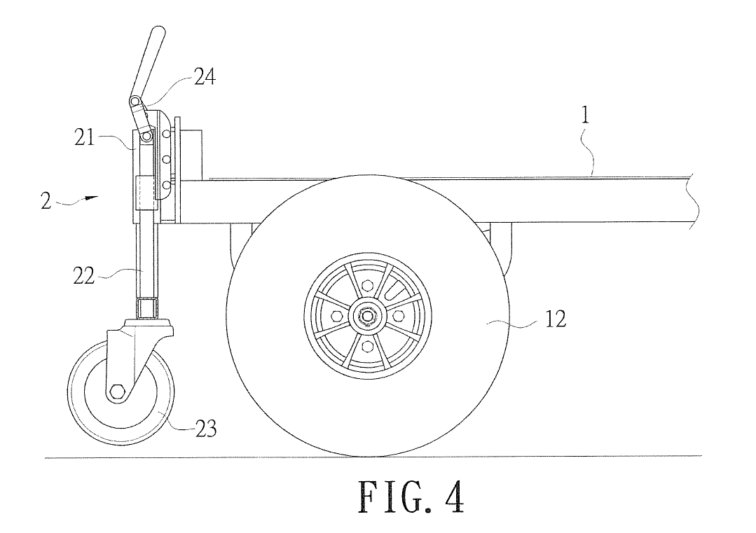

As shown in FIGS. 3 and 4, in normal condition, the auxiliary caster unit 23 is normally located above the ground and does not contact the ground, and the carry-and-transport device 1 moves by the caster unit 11 and the straight-wheel unit 12.

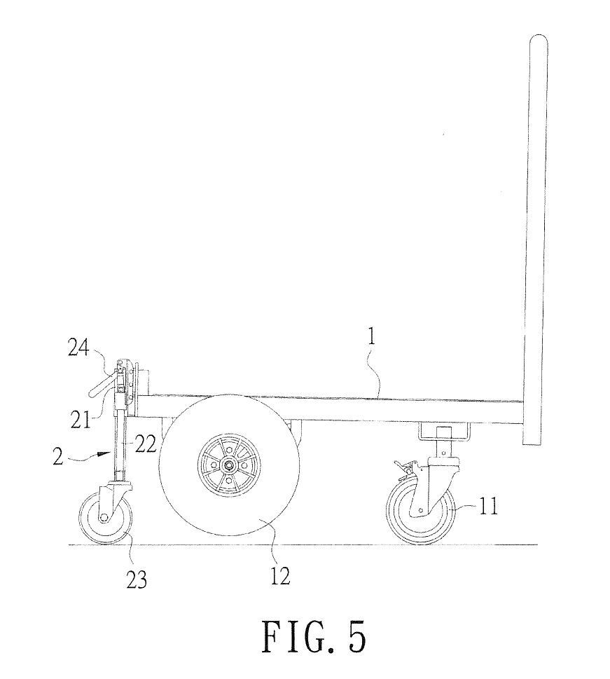

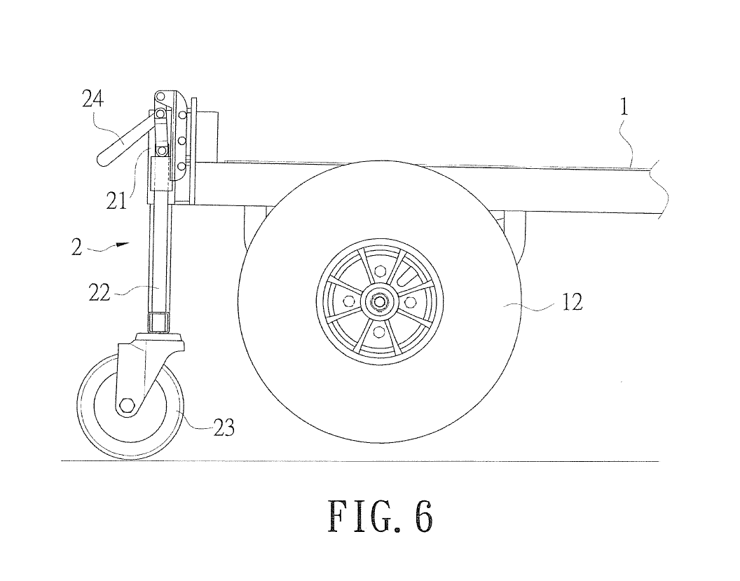

When the carry-and-transport device 1 turns or makes a U-turn, as shown in FIGS. 5 and 6, the user operates the switch unit 24 of the control unit 2 to move the movable frame 22 downward. The auxiliary caster unit 23 is lowered to touch the ground, and the straight-wheel unit 12 is lifted and does not touch the ground when the auxiliary caster unit 23 touches the ground. Therefore, the carry-and-transport device 1 can easily turn or make a U-turn by the caster unit 11 the auxiliary caster unit 23. The required turning radius of the carry-and-transport device 1 is significantly reduced.

The carry-and-transport device 1 of the present invention has the control unit 2 located at the straight-wheel unit 12, so that when the carry-and-transport device 1 turns or makes a U-turn, the auxiliary caster unit 23 is lowered and touches the ground to help the carry-and-transport device 1 to turn or make a U-turn. The required turning radius of the carry-and-transport device 1 is significantly reduced.

While we have shown and described the embodiment in accordance with the present invention, it should be clear to those skilled in the art that further embodiments may be made without departing from the scope of the present invention.

What is claimed is:

1. A carry-and-transport device comprising:
a caster unit and a straight-wheel unit;
a control unit having a sleeve which is located corresponding to the straight-wheel unit, a movable frame connected to the sleeve and having an auxiliary caster unit connected to a lower end thereof, the auxiliary caster unit being normally located above the ground, and
a switch unit connected to a top of the movable frame which controls the movable frame to move upward and downward.

2. The carry-and-transport device as claimed in claim 1, wherein the carry-and-transport device is a transportation cart, a manual cart or a bed.

3. The carry-and-transport device as claimed in claim 1, wherein the switch unit of the control unit is a lever.

4. The carry-and-transport device as claimed in claim 1, wherein the switch unit of the control unit is a hydraulic cylinder, a pneumatic cylinder or an electric cylinder.
